(19) United States
(12) Patent Application Publication
(10) Pub. No.: US 2016/0245257 A1
(43) Pub. Date: Aug. 25, 2016

(54) SYSTEM FOR PITCH CONTROL

(71) Applicant: MITA-TEKNIK A/S, Rødkærsbro (DK)

(72) Inventor: Torben Jensen, Sabro (DK)

(73) Assignee: MITA-TEKNIK A/S, Rødkærsbro (DK)

(21) Appl. No.: 15/029,714

(22) PCT Filed: Oct. 16, 2014
(86) PCT No.: PCT/DK2014/050337

§ 371 Date: Apr. 15, 2016

(30) Foreign Application Priority Data
Oct. 18, 2013 (DK) PA 2013 70594

(51) Int. Cl. F03D 7/02; H02J 11/00; F03D 9/00; F03D 3/06; F03D 7/04; F03D 7/06; F03D 1/06; H02P 9/06; H02K 7/18

(52) U.S. Cl. CPC F03D 7/0224; H02P 9/06; H02J 11/00; F03D 9/003; H02K 7/183; F03D 7/042; F03D 7/06; F03D 1/0675; F03D 3/062; F05B 2270/602

(57) ABSTRACT

A system for electric pitch control primarily for wind turbine blades, has at least one first electric motor which is electrically coupled to a first electronic control device, which electronic control device controls the operation of the motor which drives a gear mechanism via a clutch that has a tooth wheel that drives a tooth ring which is mechanical fixed to the root of a wind turbine blade for performing pitch regulation. To improve the reliability of an electric pitch control system the system has at least one second motor which is electrically coupled to a second electronic control device which is coupled to the power grid and controls the operation of the second motor. The second motor has a shaft which drives a second gear mechanism via clutch. The second gear mechanism has at least one second tooth wheel, which second tooth wheel drives the tooth ring.

### BACKGROUND OF THE INVENTION

1. Field of the Invention

The present invention relates to a system adapted for electric pitch control primarily for wind turbine blades, which system comprises at least a first subsystem which subsystem comprises at least one first electric motor, which motor is electrically coupled to a first electronic control device, and to a power grid, which electronic control device controls the operation of the electric motor, which electric motor comprises a shaft, which shaft is through a brake, and through a clutch driving a gear mechanism, which gear mechanism comprises at least one tooth wheel, which tooth wheel drives a tooth ring, which tooth ring is mechanically fixed to the root of a wind turbine blade for performing pitch regulation.

2. Description of Related Art

Pitch control of wind turbine blades has been used for several years. Both hydraulic and electric servo systems have been used for pitch control. U.S. Pat. No. 8,172,532 B2 discloses some general aspects of a device for adjustment of a pivotally mounted rotor blade of a wind energy converter. The device comprises a first drive and a second drive that cooperate to turn the rotor blade between an operating position and a feathered position. The device further comprises a first actuatable lockout connected to the rotor blade which in an activated state prevents turning of the rotor blade into the operating position, but allows turning of the rotor blade into the feathered position. Under further aspects, the invention provides a wind energy converter comprising the device and a method for adjusting a rotor blade which is pivotally mounted on a rotor hub of a wind energy converter.

### SUMMARY OF THE INVENTION

It is an object of the invention to improve the reliability of an electric pitch control system for wind turbines. A further object of the invention is to isolate failures and continue mostly normal operation if a failure occurs in an electric pitch control system.

This can be achieved by a system as disclosed in the opening paragraph and modified as the system comprise at least a second subsystem, which second subsystem comprises at least one second motor, which second motor is electrically coupled to a second electronic control device, which second electronic control device is coupled to the power grid and to the common communication network, which second electronic control device controls the operation of the second motor, which second motor comprises a shaft, which shaft is through a brake, and through a second clutch driving a second gear mechanism, which second gear mechanism comprises at least one second tooth wheel, which second tooth wheel drives the tooth ring, whereby the first and the second subsystem is interconnected in that the first electronic control device can perform control of the second clutch, which second electronic control device performs control of the first clutch.

Hereby, it can be achieved that two parallel operating electric motors are driving the same tooth ring for the pitch control of a wind turbine blade. Because two parallel systems operate, the power that can be generated by operating only by one electric motor. But the reliability is extremely high because failure in one part of the system might let the other system operate at a slower speed, but still full operational. This increasing reliability is very important in offshore wind farms where service is difficult and probably not possible within short time so failure in a pitch control system can lead to lack of operation of the wind turbine, maybe for weeks. By parallel coupling of two electronic control devices and together with the motors, the whole control system for pitch regulation will change in the situation where one part of the system has a fault. Of course, in some systems, where rapid regulation of pitch in the direction of neutral is necessary, there can be limitations in the way of operation if part of a control system is not in operation. Therefore, some limitations have to be accepted in the wind turbine operation, if one part of a pitch regulation system is not in operation. Maybe the wind turbine will not be able to operate with maximum wind speed, but will have a lower limit for shutting down than by usual operation where both pitch systems are working. By cross connection of the clutch control the first part of the system is able to communicate with the clutch of the other system. And the second part of the system will be able to communicate with the clutch of the first system. Hereby, the electronic control devices can have information about the situation and therefore also the position of the clutch in the other side. In a failure system in one of the control systems or one of the motors, it is possible for the operating electronic control device to open the clutch in the other side and in that way take over the whole command and perform traditional regulation with one electronic control device and one motor. Hereby, total reliability of the system is further improved.

In a further preferred embodiment of the invention, the first electronic control device and the second electronic control device can perform communication over a common communication line. By the communication system between the electronic control devices, it is possible for the systems to operate more or less synchronously which could be rather important for letting two different motors drive at the same tooth ring. If no synchronization is performed power from one of the motors would probably be used for drive the other motor to an unwanted higher velocity, and therefore there would simply be a loss of power instead of achieving parallel operation. The common communication also gives the possibility that failure information can be communicated between the two electronic control devices. Also in this way one of the electronic control devices can communicate to the opposite and take over the command and perform the control by itself.

In a further preferred embodiment of the invention, the system can comprise at least a third subsystem, which third subsystem comprises a third motor, which third electronic control device is coupled to the power grid, which third electronic control device controls the operation of the third motor, which third motor comprises a third shaft, which shaft is connected to a brake, which third shaft is through a third clutch driving a third gear mechanism, which third gear mechanism comprises at least one second tooth wheel, which second tooth wheel drives the tooth ring. Instead of multiplying the system by a factor two it is possible also to multiply by a factor three or maybe even more. By increasing the number of motors and electronic control devices it might be possible to distribute the pitch control into a higher number of smaller electronic devices controlling smaller motors. In this way it might be possible to build a standard electronic pitch control system that can be used in wind turbines of different sizes where the number of systems coupled parallel is depending on the power that is needed for the pitch control. In that way relative cheap, high reliable control can be performed.

In a further preferred embodiment of the invention, the third electronic control device can perform control of the first or the second clutch, which first or second electronic control device performs control of the third clutch. As previously disclosed the different systems are able to control other clutches.

In a further preferred embodiment of the invention, the first electronic control device, the second electronic control device and the third electronic control device can perform communication over a common communication line. The communication line will of course also be connected to the third, fourth, fifth or to the many systems operating in parallel.

In a further preferred embodiment of the invention, each of the motors can be connected to encoders, which encoders communicate with the related electronic control devices. Encoders are necessary at least for synchronization of the different motors in order to let them operate synchronously in relation to each other. But also for the electronic control device, the encoding signals are important in order to control the power that has to be used for driving the motor.

In a further preferred embodiment of the invention, each of the electronic control devices can be connected to emergency energy storage, which energy storages can be coupled in parallel. Hereby, it can be achieved that energy storages continuously can be charged as long as there is a power supply from the power grid. In situations where for example the power grid fails, it is possible for the electronic control devices to still be active and by motors, clutches and gear to turn the pitch of a wind turbine blade into a neutral position where the wind turbine blade has to be placed in all power down situations. It is preferred that energy storage directly coupled to the electronic control devices is also parallel coupled in a way where they can supply in common in emergency situations, where for example one of the electronic control devices or one of the motors are not operational because of fault. In that situation it is positive that still existing parts of the system are able to operate also with the power that has already been stored in one of the extra energy storages. A lot of different battery types can be used, but in the future capacitor energy storage will probably be the most effective type of energy storage having sufficient energy stored. In a preferred embodiment of the invention, the energy storage can be any liquid or gas pressure storage from which energy storage the energy for emergency shutdown of the pitch control is possible.

In a further preferred embodiment of the invention, it is possible that the clutch is placed between the gear and the tooth ring. Many different constructions for the clutch are possible, but a very simple clutch will by an actuator release the tooth wheel from the tooth ring and in that way uncouple the connection between the tooth wheel and the tooth ring. This primitive clutch will be sufficient in many emergency situations, where one of the components in connection with one of the motors will fail. That could be the electronic control device, the motor or maybe the brake. In all of these situations it is possible that rotation of the motor will be blocked, more or less mechanical or maybe electrical and rotation of that motor by the tooth ring will at least have an energy consumption that is unnecessary. Therefore, it is very important that the clutch in some way can disconnect any connection to the motor unit.

### BRIEF DESCRIPTION OF THE DRAWINGS

FIG. 1 discloses one possible embodiment of the invention.

FIG. 2 shows one further possible embodiment of the invention.

### DETAILED DESCRIPTION OF THE INVENTION

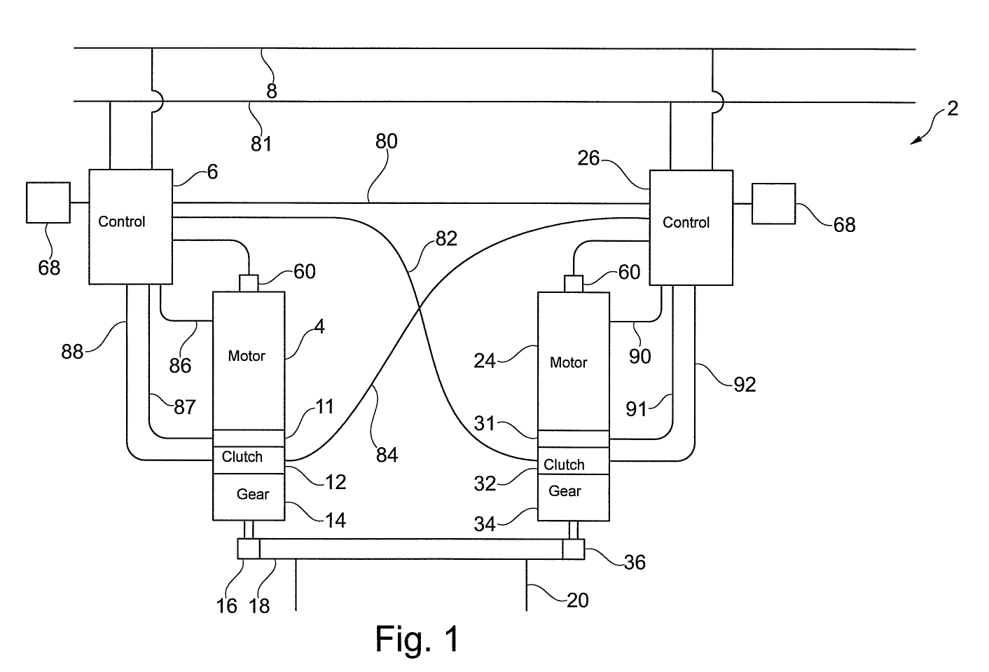

FIG. 1 shows a system 2 for pitch regulation of a wind turbine blade. The system shows one first motor 4, which motor is connected to an electronic control device 6, which device is electrically connected to a power grid 8. The first motor 4 is through a brake 11 and further through a clutch 12 driving a gear mechanism 14. The gear mechanism 14 drives a tooth wheel 16, which tooth wheel 16 is connected to a tooth ring 18, which ring 18 is fixed to the root 22 of a wind turbine blade. Furthermore, FIG. 1 shows a second motor 24, which motor 24 is by connection line 90 connected to the electronic control device 26. This electronic control device 6 is further supplied from the power grid 8 and to a common wind turbine communications network 81. The motor 24 is connected to a clutch 32 into a gear mechanism 34. This gear mechanism is driving a tooth wheel 36, which tooth wheel 36 is connected to the tooth ring 18. Furthermore, FIG. 1 indicates encoders 60, which encoders are connected to the electronic control devices 6 or 26. Further is indicated emergency energy storage 68 connected to the electronic power device 6 and 26. Furthermore, the electronic control device 6 and the electronic control device 26 are connected by a communication line 80. By 86 is indicated the power connection between the electronic control device 6 and the motor 4. By 88 is indicated a control line that is performing communication of control information from the electronic control device 6 towards the clutch 12. Furthermore, a line 92 is connected from the electronic control device 26 towards the clutch 32. Furthermore, clutch communications are performed from the electronic control device 6 by the line 92 to the clutch 32. Furthermore, a communication line 84 is connected to the second electronic control device 26 and to the first clutch 12.

In operation, both the motor 4 and the motor 24 will be able to turn the tooth ring 18. That means that the different parts of the systems are operating in full parallel. This will of course increase the total power that can be delivered to the tooth ring 18, but the primary benefit by this invention is in emergency or failure situations were for example one of the motors 4 or 24 have a fault or one of the electronic control devices 6 or 26 have a fault. Furthermore, it is possible that one of the brakes 11, 31 or 61 can have a fault so that the brake is blocked. Then it is very important that the clutch is placed after the brake so that the clutch is able to disconnect the whole section where the brake has a failure. Otherwise the brake would be able to stop any pitch control. Therefore, the possibility of having the clutch in connection with the brake makes it possible that a total mechanical disconnection will be possible. In this way, it leads to further improvement of the reliability of the pitch control system.

In that situation, the other electronic control devices, which are still operational will take command of the clutch of the other motor and open the clutch so that the non-functioning motor or electronic control device have no influence on the tooth ring 18. In that situation the system can continue operation even in a fault mode. The only limitation is that the total power will be limited. In fault situations where for example failure occurs on the power grid, which could occur in situations where a wind turbine is forced to power down the energy storage 68, will supply the electronic control devices 6 and 26 so that they are still able to perform control of the motors 4, 24 and thereby perform a shutdown of the wind turbine, even after a total power failure of the grid. In a situation where one of the electronic devices 6 or 26 has a failure or one of the motors 4, 24 has a failure, it is possible that the energy storages 68 are coupled in parallel so that in situations where one part of the system is not operational because of fault, the power stored in the energy storage can still be used at the still operating device.

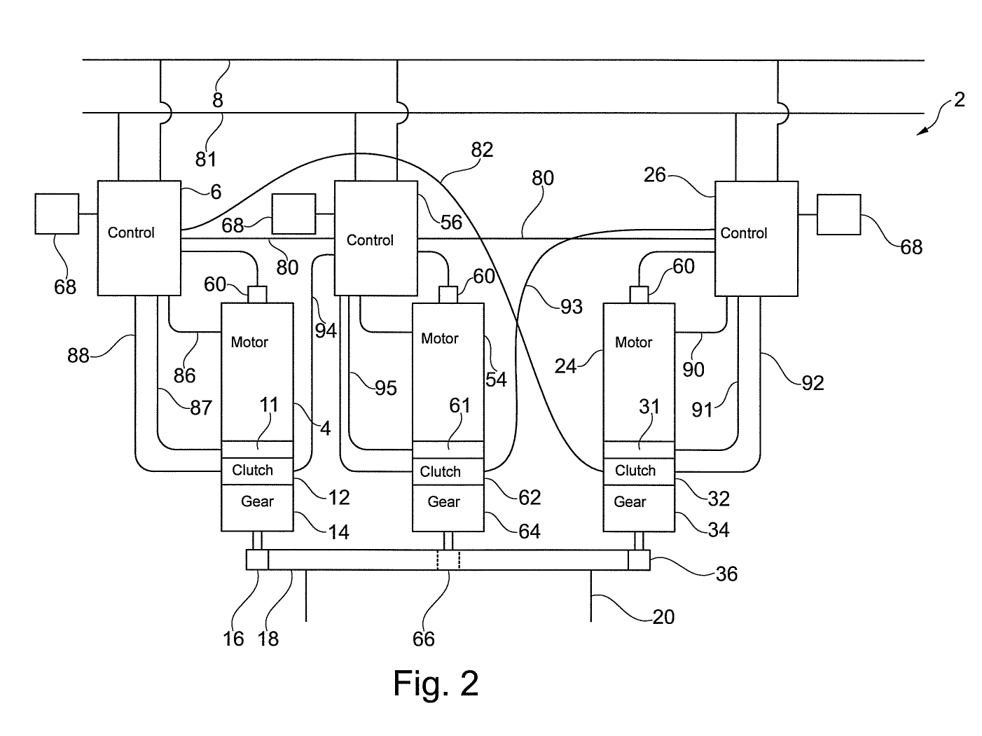

FIG. 2 mainly shows the same features as in FIG. 1, but with the major difference that now the system comprises three parallel systems.

FIG. 2 shows a third motor 54, which is driven by an electronic control device 56, which motor is connected to a clutch 62 into a gear mechanism 64. Further a tooth wheel 66 indicated behind the tooth ring 18, is connected to this tooth ring 18 and can also perform rotation of the tooth ring 18. Communication line 94 from the electronic control device 56 is connected to the clutch 12. Further is a communication line 93 connected from the electronic control device 26 to the clutch 62.

Further fail-safe operation is possible in situations where the pitch control system is formed three times. Three parallel operating motors and electronic control devices will give a very high reliability for the system. This can be very important for offshore wind turbines where service is critical and only can be performed when ships or helicopters are available and when the weather situation allows service. Therefore, reliability of the pitch control system is extremely important. It is possible in some systems, maybe even to place more than the three motors indicated connected to the same rotating ring 18. In that situations even smaller motor systems can be used and the reliability will be extremely high if for example eight units are parallel operating, where for example four of them mainly operate in order to perform normal operation, but as long as two of them are in operation, maybe still some pitch control is possible but with some limitations in the operation of the wind turbine.

What is claimed is:

1-7. (canceled)

8. A system for electric pitch control of a wind turbine, comprising:
at least a first subsystem which first subsystem comprises:
at least one first electric motor which is electrically coupled to a first electronic control device, the first electronic control device being coupled to a power grid and to a common communication network, the first electronic control device being configured for controlling operation of the first electric motor, wherein the first electric motor comprises a first shaft which drives a first gear mechanism through at least one first brake and through a first clutch, first gear mechanism having at least one first tooth wheel which drives a tooth ring that is mechanically fixed to a root of a wind turbine blade for performing pitch regulation, and
at least a second subsystem, which second subsystem comprises:
at least one second electric motor which is electrically coupled to a second electronic control device, the second electronic control device being coupled to the power grid and to the common communication network, the second electronic control device being configured for controlling operation of the second motor, wherein the second motor comprises a second shaft which drives a second gear mechanism through at least one second brake and through a second clutch, the second gear mechanism having at least one second tooth wheel which drives the tooth ring,
wherein the first and the second subsystems are interconnected in a manner such that the first electronic control device controls the second clutch, and the second electronic control device controls the first clutch.

9. The system according to claim 8, wherein the first electronic control device and the second electronic control device communicate through one of a common communication line or a common wind turbine communication network.

10. The system according to claim 9, further comprising at least a third subsystem which comprises a third motor, and a third electronic control device connected to the power grid and to the common wind turbine communication network, the third electronic control device controlling operation of the third motor, the third motor having a third shaft which drives a third gear mechanism through at least one brake and through a third clutch, the third gear mechanism having at least one third tooth wheel which drives the tooth ring.

11. The system according to claim 10, wherein the third electronic control device controls the first or the second clutch, and the respective first or second electronic control device controls the third clutch.

12. The system according to claim 11, wherein the first electronic control device, the second electronic control device and the third electronic control device communicate through a common communication network.

13. The system according to claim 12, wherein each of the motors are connected to encoders that communicate with the electronic control devices.

14. The system according to claim 13, wherein each of the electronic control devices are connected to energy storages for emergency power supply of the motors, which energy storages are coupled in parallel.
